(19) United States
(12) Patent Application Publication
(10) Pub. No.: US 2014/0314417 A1
(43) Pub. Date: Oct. 23, 2014

(54) RECONFIGURATION OF AN OPTICAL CONNECTION INFRASTRUCTURE

(71) Applicants: Kevin B. Leigh, Houston, TX (US); David Jay Koenen, Cypress, TX (US); Guodong Zhang, Plano, TX (US); Michael Steven Schlansker, Los Altos, CA (US); Jean Tourrilhes, Mountain View, CA (US); Gary William Thome, Tomball, TX (US); Ian Moray McLaren, Bristol (GB)

(72) Inventors: Kevin B. Leigh, Houston, TX (US); David Jay Koenen, Cypress, TX (US); Guodong Zhang, Plano, TX (US); Michael Steven Schlansker, Los Altos, CA (US); Jean Tourrilhes, Mountain View, CA (US); Gary William Thome, Tomball, TX (US); Ian Moray McLaren, Bristol (GB)

(21) Appl. No.: 14/369,596

(22) PCT Filed: Apr. 12, 2012
(86) PCT No.: PCT/US12/33179

§ 371 Date: Jun. 27, 2014

(51) Int. Cl. H04L 12/24; H04B 10/278; H04L 7/00; H04B 10/272; H04J 14/08

(52) U.S. Cl. CPC H04L 41/12; H04B 10/272; H04J 14/08; H04L 7/0075; H04B 10/278
USPC 398/79; 398/140; 398/154

(57) ABSTRACT

An optical connection infrastructure has optical conduits between first devices and at least one second device. Dynamic reconfiguration of the optical connection infrastructure can be performed from a first connection topology to a second, different connection topology based on programming of the first devices.

### BACKGROUND

A network can include various electronic devices that are connected to each other, such as through one or multiple switches. Data communication with or among the electronic devices is accomplished through the switch(es). In some cases, the connection infrastructure between the electronic devices and the switch(es) can include an optical connection infrastructure, which includes optical signal conduits (e.g. optical fibers or optical waveguides).

### BRIEF DESCRIPTION OF THE DRAWINGS

Some embodiments are described with respect to the following figures:

FIGS. 1A-1C illustrate different network topologies, according to some examples;

FIG. 2 illustrates interconnection between an electronic device and a switch, according to some examples;

FIG. 3 is a block diagram of an example arrangement that includes devices interconnected by an optical connection infrastructure, and a controller according to some implementations;

FIG. 4A-4B illustrate programmatic settings of network interface components for different network topologies of an optical connection infrastructure, according to some implementations;

FIG. 5A illustrates components of an optical connection infrastructure, according to some implementations;

FIG. 5B illustrates use of a bus device to interconnect electronic devices and a switch, according to some implementations;

FIG. 6 illustrates a mechanism for loop-back clock synchronization between a network interface component and a switch, according to some implementations; and

FIG. 7 is a message flow diagram of a flow to perform arbitration for a shared bus, according to some implementations.

### DETAILED DESCRIPTION

In a network, different connection topologies can be used to interconnect electronic devices to intermediate devices, such as switches. Electronic devices can communicate with each other through a network that includes the switches or other types of intermediate devices. Examples of electronic devices include client computers, server computers, storage devices, and so forth. A “switch” can refer to any device used for passing data among the electronic devices or between the electronic devices and other devices. A “switch” can also refer to a router or a gateway or any other type of device that allows for interconnection between different devices.

In the ensuing discussion, reference is made to arrangements in which electronic devices are connected to a switch (or multiple switches). It is noted that techniques or mechanisms according to some implementations can also be applied in other contexts in which different devices are interconnected to each other using a connection infrastructure.

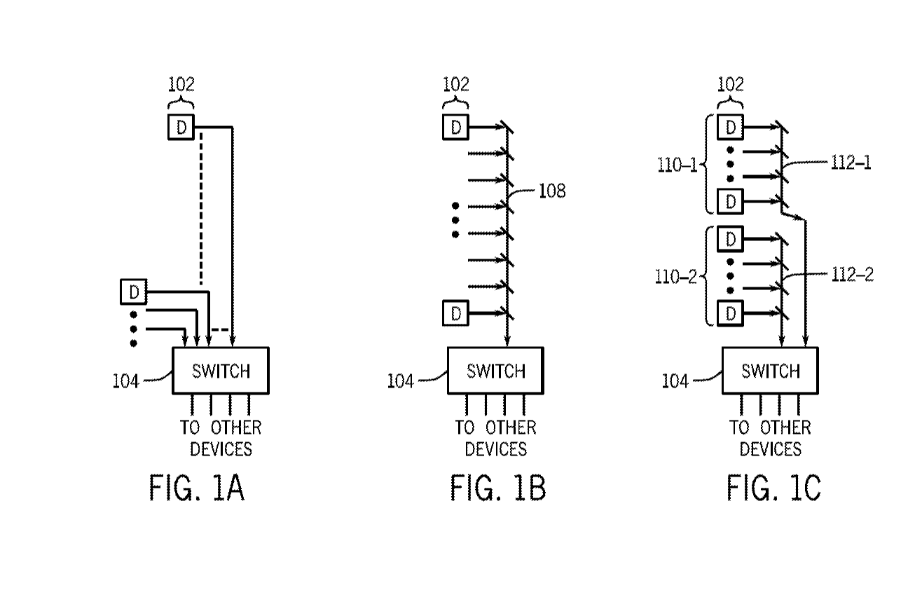

A “connection topology” of a connection infrastructure to interconnect electronic devices to a switch can refer to a specific arrangement of signal paths that are used to interconnect the electronic devices with the switch (or switches). FIGS. 1A-1C depict three different example connection topologies. FIG. 1A depicts a star connection topology, in which electronic devices 102 are interconnected to a switch 104 in a star arrangement. More specifically, with the star connection topology, each of the electronic devices 102 is connected to the switch 104 using a point-to-point connection.

FIG. 1B illustrates a bus connection topology, in which electronic devices 102 are interconnected to the switch 104 over a bus 108 that is shared by the electronic devices 102. FIG. 1C illustrates yet another example connection topology, which is a hybrid star-bus connection topology. in the hybrid star-bus connection topology, multiple groups of electronic devices (groups 110-1, . . . 110-n are shown, where n≧2) are connected over respective buses 112-1, . . . , 112-n to the switch 104. Within each group (110-i, where i=1 to n), the electronic devices share the corresponding bus 112-i. Thus, the electronic switches of a group 110-i are interconnected to the switch 104 by a bus connection topology, while the different groups 110-1 to 110-n are interconnected to the switch 104 using a star connection topology. Such a combination of the bus connection topology and the star connection topology provides the hybrid star-bus connection topology.

Although some example connection topologies are illustrated in FIGS. 1A-1C, it is noted that in other examples, there can be other types of connection topologies for interconnecting devices.

In some implementations, the connection infrastructure used between the electronic devices and a switch (or multiple switches) is an optical connection infrastructure. The optical connection infrastructure includes optical signal conduits, where an optical signal conduit can include an optical fiber or optical waveguide and associated components, such as reflectors, splitters, and so forth.

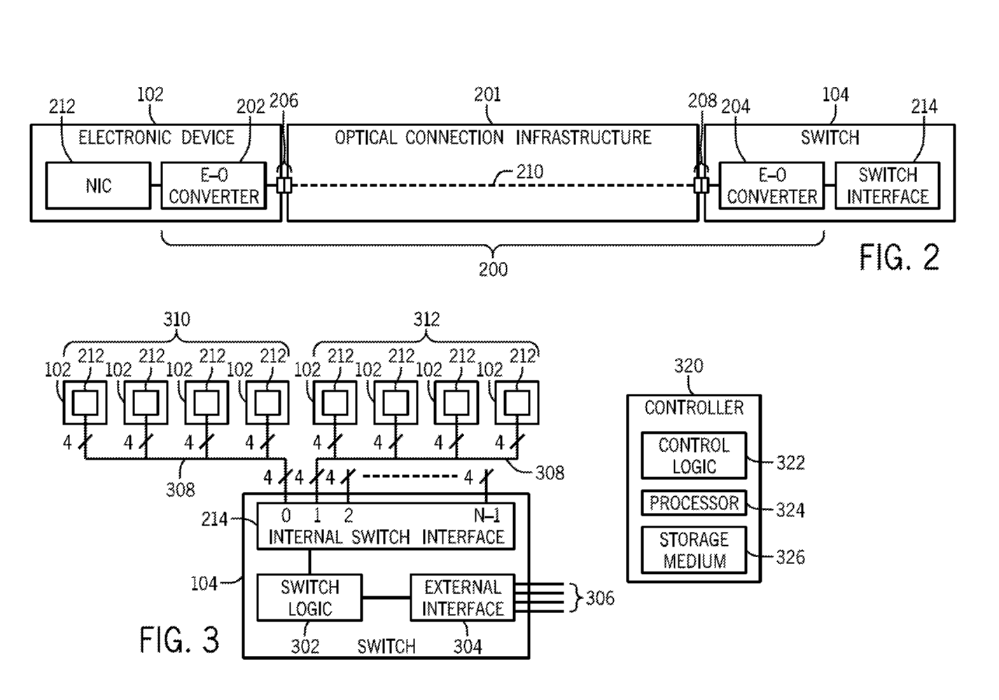

An optical signal conduit is part of an optical link, which includes the optical signal conduit in addition to other components, such as optical connectors (e.g. blind-mate optical connectors) and electrical-optical converters (to convert between electrical signals and optical signals). For example, as shown in FIG. 2, an optical link 200 includes an electrical-optical converter 202 in an electronic device 102 and an electrical-optical converter 204 in the switch 104. The optical link 200 also includes optical connectors 206 to interconnect the electronic device 102 to an optical connection infrastructure 201, and optical connectors 208 to interconnect the switch 104 to the optical connection infrastructure 201. In addition, the optical connection infrastructure 201 includes optical signal conduits 210, which include optical fibers or optical waveguides and associated components, such as reflectors, splitters, and so forth.

As further shown in FIG. 2, the electronic device 102 includes a network interface card (NIC) 212, which communicates electrical signals with the electrical-optical converter 202 in the electronic device 102. Similarly, the switch 104 includes a switch interface 214 that communicates electrical signals with the electrical-optical converter 204 in the switch 104. The switch interface 214 is configured to communicate signals of the switch 104 with the optical connection infrastructure 201.

In the example of FIG. 2, the NIC 212 in the electronic device 102 is depicted as having a single-lane port connected to the optical signal path 200. In other examples, the NIC 212 can include a multi-lane port that is connected to respective optical signal paths. A multi-lane port refers to a port that is able to communicate over multiple lanes of a path. A lane can refer to a transmit optical signal path and a receive optical signal path.

Depending on operations or applications to be provided in a network, one connection topology may be more efficient than another connection topology (such as in terms of connectivity cost versus connection bandwidths). However, it can be difficult to change the connection topology of an optical connection infrastructure (such as the optical connection infrastructure 201 of FIG. 2). In some cases, to change the connection topology, physical components of the optical connection infrastructure may have to be replaced, which can be time-consuming and complex.

In addition to changing connection topologies of optical connection infrastructures for different operations or applications in a network, it may also be desirable to change connection topologies to accommodate new designs of electronic devices or switches. It may also be desirable to modify a connection topology in response to a changing networking standard, or in response to a changing environment of an enterprise (e.g. business concern, government agency, business organization, individual, etc.).

In accordance with some implementations, dynamic reconfiguration of an optical connection infrastructure can be performed without replacing or modifying any physical components of the optical connection infrastructure. In some implementations, the dynamic reconfiguration is performed by programmatic reconfiguration (between different settings) of network interface components (such as the NIC 212 of FIG. 1) in electronic devices. A “network interface component” (NIC) refers to hardware circuitry (and possibly also machine-readable instructions) that provides communication functionality to allow an electronic device to communicate over a network.

FIG. 3 illustrates an example arrangement that has electronic devices 102 interconnected to the switch 104. The switch interface 214 of the switch 104 has multiple ports 0, 1, . . . , N−1, where N≧2. The switch interface 214 can be considered an internal switch interface, in the sense that the switch interface 214 is connected to the electronic devices 102 (which may be part of a rack or other type of container). The switch 104 further includes switch logic 302 provided between the internal switch interface 214 and an external switch interface 304, which is connected to external ports 306 or connected to other devices (which can be outside the rack or container that includes the electronic devices 102).

Note that in the example in FIG. 3, the electrical-optical converter 204 of the switch 104 that is depicted in FIG. 2 is omitted for purposes of brevity.

Each port of the internal switch interface 214 is a four-lane port in the depicted example. Each four-lane port of the internal switch interface 214 is connected to a four-lane path 308, which is connected to four electronic devices 102. Thus, each four-lane port of the internal switch interface 214 is connected to a respective group of four electronic devices 102. Each four-lane path 308 is connected to the NICs 212 of the electronic devices 102. Note that each NIC 212 has a four-lane port to communicate with the four-lane path 308. Also, the electrical-optical converter 202 (shown in FIG. 2) is not depicted in the electronic devices 102 of FIG. 3 for brevity.

Multiple groups 310 and 312 of electronic devices 102 are shown in FIG. 3. Although two groups are shown in the example of FIG. 3, note that more than two groups can be used in further examples. Also, although FIG. 3 shows that each group 310 or 312 has four electronic devices 102, different numbers of electronic devices 102 can be included in each group in other examples.

The various paths between the switch 104 and the electronic devices 102 are part of the optical connection infrastructure 201 of FIG. 2. In accordance with some implementations, the connection topology of the optical connection infrastructure 201 can be modified by reprogramming the NICs 212 of the electronic devices 102 between different settings, as discussed further below. Programmatically reconfiguration of the connection topology of the optical connection infrastructure 201 allows for more efficient connection topology modification, since physical components do not have to be removed and replaced to achieve the connection topology modification.

In some examples, each one of the multiple groups 310 and 312 can be reconfigured to change the network topology of the optical connection infrastructure 201. In other examples, less than all of the multiple groups 310 and 312 can be reconfigured to change the network topology.

The flexibility in reconfiguring the network topology of the optical connection infrastructure 201 allows an enterprise to balance performance, power, and cost in connecting electronic devices to one or multiple switches. Also, mechanisms according to some implementations for connecting electronic devices to a switch allow for a reduction in the number of ports that have to be provided on the switch.

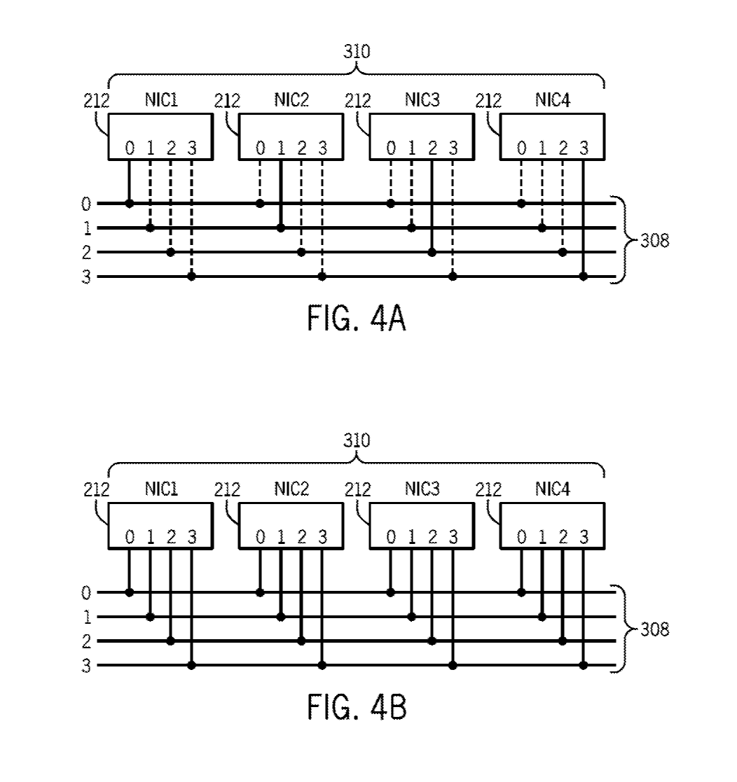

FIGS. 4A and 4B depict two different connection topologies between the electronic devices 102 of the group 310 and the switch 104. FIG. 4A shows that each lane of the four-lane path 308 is dedicated to a respective different NIC 212 of a corresponding electronic device in the group 310. Lane 0 of the path 308 is dedicated to NIC1, lane 1 is dedicated to NIC2, lane 2 is dedicated to NIC3, and lane 3 is dedicated to NIC4. The dedicated connections between the lanes of the multi-lane path 308 and the respective NICs in the group 310 are depicted with solid lines.

FIG. 4A also shows dashed lines between each of the NICs 212 and the other lanes of the multi-lane path 308. The dashed lines indicate that although there is a physical connection between these lanes and each NIC 212, communication between the NIC and such lanes over the connections represented by dashed lines are disabled. Effectively, for each four-lane port of a corresponding NIC 212, three of the four lanes of the port are disabled (just one lane of the four-lane port is enabled for communications over the path 308).

In the example of FIG. 4A, for NIC1, lane 0 of the four-lane port is enabled between NIC1 and the path 308 (but lanes 1, 2, 3 of the four-lane port of NIC1 are disabled). Similarly, lane 1 of the four-lane port of NIC2 is enabled (but lanes 0, 2, 3 are disabled), lane 2 the four-lane port of NIC3 is enabled (but lanes 0, 1, 3 are disabled), and lane 3 the four-lane port of NIC4 is enabled (but lanes 0, 1, 2 are disabled).

With the arrangement of FIG. 4A, a star topology is provided between the NICs of the group 310 and the switch 104. The NICs of the group 312 can similarly be connected to the switch 104 using a star topology.

FIG. 4B shows a different network topology, in which all four lanes of the four-lane port of each NIC 212 in the group 310 are enabled. As a result, each lane of the multi-lane path 308 is shared by all four NICs 212 in the group 310, to provide a shared bus topology. However, the groups 310 and 312 (FIG. 3) are connected to the switch 104 using a star topology—as a result, the network topology of FIG. 4B allows for provision of the hybrid star-bus topology.

For the FIG. 4B network topology, in some examples, the switch interface can contain at least one internal MAC (medium access control) entity to communicate with each corresponding NIC 212. In addition, the switch interface can further include a Single Copy MAC entity for handling broadcast of a data unit, such as described in the IEEE 802.3ah Multi-point MAC Control Protocol (MPCP). In some examples, the switch 104 determines which internal MAC port a data unit is to egress from based on a mapping table, such as a MAC-VLAN (virtual local area network)-Port table. A broadcast frame destined for all downstream NICs are broadcast from the Single Copy MAC entity. In some examples, each switch MAC/NIC pair can be assigned its own logical link identifier (LLID), also described in IEEE 802.3ah. Since the switch has already determined which NIC to send data to, the NIC does not have to maintain a complete list of all MAC address to filter on; rather the NIC accepts frames with its LLID and the broadcast LLID.

Each NIC 212 can be reconfigured by reprogramming a predefined portion of the NIC. For example, the NIC 212 can include a configuration register that when programmed with different values causes different combinations of lanes of the four-lane port to be enabled and disabled. Alternatively, the NIC 212 can include one or multiple input control pins that can be driven to different values to control the enabling/disabling of the lanes of the four-lane port.

Reconfiguring the NICs of the electronic devices in the group 310 to change the network topology between the star topology (FIG. 4A) and the bus topology (FIG. 4B) can be accomplished during operation of the NICs, or during a boot procedure of the NICs.

The dynamic reconfiguration of the NICs 212 to provide the different connection topologies can be controlled by a controller 320. The controller 320 can be part of the switch 104, or alternatively, the controller 320 can be a system controller (e.g. rack controller) that is able to communicate with the switch 104 to cause the switch 104 to reprogram the electronic devices 102.

The controller 320 can include control logic 322, which can be implemented as machine-readable instructions executable on one or multiple processors 324. The processor(s) 324 can be connected to a storage medium (or storage media) 326. The control logic 322 is executable to perform various tasks, including the control of dynamic reconfiguration of a network topology of an optical connection infrastructure.

Each lane discussed in connection with FIGS. 3 and 4A-4B can be a transmit lane or a receive lane, or both. In some examples, both transmit lanes and receive lanes are configured either as dedicated lanes or shared lanes. This provides a pseudo-symmetric bandwidth between the transmit and receive lanes, where the bandwidth in the transmit direction and receive direction are generally the same.

The control logic 322 can dynamically reconfigure the NICs lanes to be shared or dedicated. Also, dedicated NIC lanes can be reconfigured to have different dedicated lanes to handle a faulty lane condition. For example, if a dedicated lane for a NIC's transmitter becomes non-functional, then another lane can be reconfigured to be dedicated, which enables higher fault resiliency for the NIC transmit lanes. To illustrate this example, assume that NIC1's transmitter is dedicated to lane 0 and NIC2's transmitter is dedicated to lane 1. When NIC1 detects that its transmit lane is non-operational, it notifies the controller 320 and the controller 320 commands NIC2 to stop its transmission on its transmit lane 1 after the current operation. After NIC2 and the switch 104 acknowledge to the controller 320 that they have disabled use of lane 1 for communications by NIC2's transmitter, the controller 320 commands NIC1 to use lane 1 to transmit and the switch to use lane 1 to receive communication from NIC1. In addition, the controller 320 can command NIC2 to use its lane 0 to transmit and the switch to receive NIC2's communication on lane 0.

In alternative examples, the connection topology for transmit lanes and receive lanes of the switch 104 can be different. For example, the receive lanes (to communicate data sent from the electronic devices 102 to the switch 104) can be configured as dedicated lanes, while the transmit lanes (to communicate data sent from the switch 104 to the electronic devices 102) are configured as shared lanes. Such an arrangement provides asymmetric bandwidth, where greater bandwidth is available on the NIC's 212 receive lanes and less bandwidth on its transmit lanes. Asymmetric bandwidth on the transmit and receive lanes can be useful for certain applications, such as applications involving video codec translation from HDTV formats to mobile phone screen format video streams, where a relatively large bandwidth is received and processed, but less data is communicated on the transmit lanes since the transmit lanes are used to communicate data requests. If the NIC transmit lanes are dedicated (i.e. not shared), then arbitration among the NICs may not have to be used as the switch can have built-in capabilities to handle the simultaneous transactions of dedicated transmit lanes, regardless of whether the receive lanes are shared or not. For either the topology of FIG. 4B or this asymmetric case, a single copy broadcast MAC can be used in some examples in addition to the other NIC-specific MACs to handle downstream broadcast traffic.

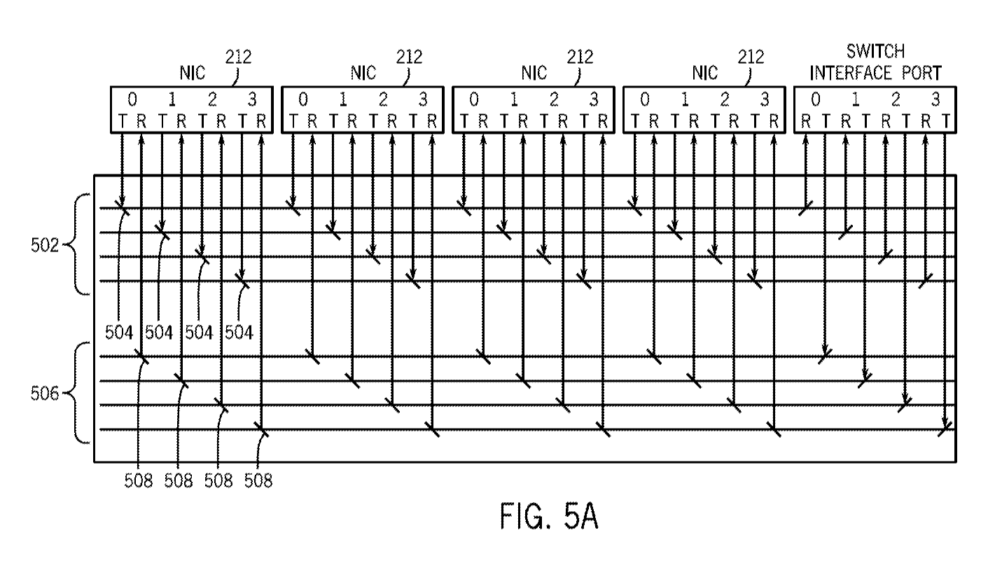

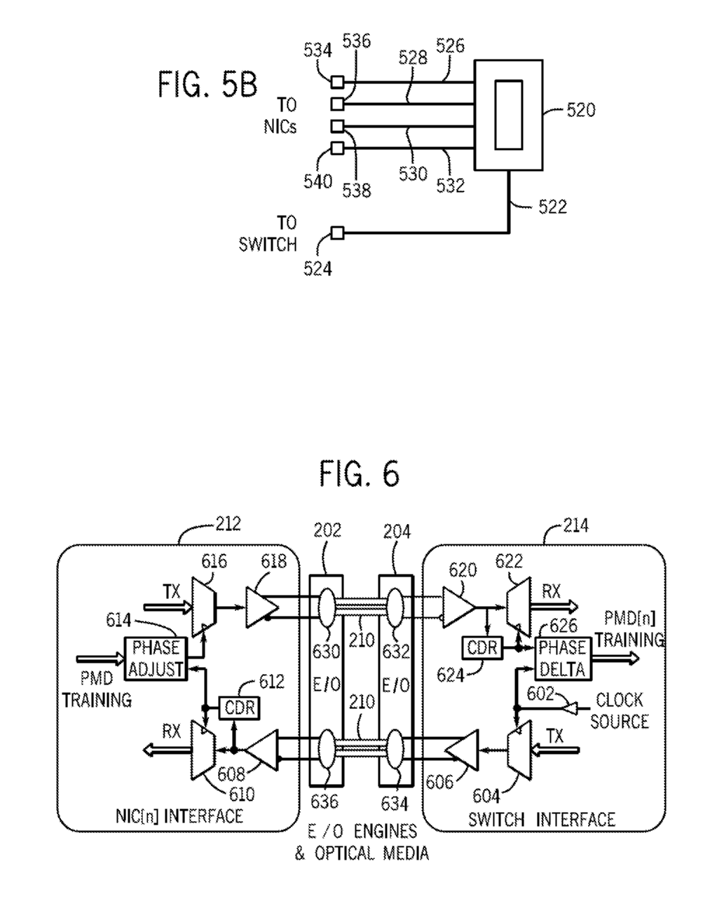

FIG. 5A illustrates the transmit (T) and receive (R) lanes of the four-lane ports of the NICs 212, which are connected to respective receive (R) and transmit (T) lanes of switch port 0. Note that the transmit lanes of the NIC port are to be optically coupled to the receive (R) lanes of the switch interface port, and similarly, the receive lanes of the NIC port are to be optically coupled to the transmit (T) lanes of the switch interface port. As noted above, the switch interface 214 has N ports (see FIG. 3). In the optical connection infrastructure, a first group 502 of optical propagation devices 504 (e.g. optical splitters, etc.) for propagating optical signals is provided for the transmit (T) lanes of the NICs 212. A second group 506 of optical propagation devices 508 are provided for the receive (R) lanes of the NICs.

An optical splitter can perform splitting and combining functions on optical signals. The optical splitters can be based on the use of optical waveguides and micro-mirrors, or other like technology. An optical signal sent over a transmit (T) lane from an NIC 212 is propagated by a respective optical splitter 504 towards the switch interface port.

In the reverse direction, an optical splitter 508 directs an optical signal from the switch interface port towards the receive (R) lane of the corresponding NIC 212.

In some examples, the groups 502 and 506 of optical propagation devices can be part of a single physical component. In different examples, the groups 502 and 506 of optical propagation devices can be part of two different physical components, where one physical component includes the group 502 of optical propagation devices, and another physical component includes the group 506 of optical propagation devices.

According to other implementations, FIG. 5B shows use of a bus device 520 to interconnect electronic devices. The bus device 520 allows the sharing of a switch interface port by multiple NICs. The bus device 520 can be a five-tap bus device, where a first tap is connected over an M-fiber optical link 522 (e.g. fiber ribbon) to a 1×M (where M≧2) ferrule 524 to the switch 104. Generally, a “ferrule” refers to an interface for an optical fiber, where the interface allows for optical communication between the optical fiber and another optical component.

The other four taps of the five-tap bus device 520 are connected over respective M-fiber optical links 526, 528, 530, and 532 to respective 1×M ferrules 534, 536, 538, and 540 to corresponding NICs 212.

FIG. 6 shows the clock synchronization between a NIC 212 of an electronic device 102 and the switch interface 214 of the switch 104, according to some examples. The switch interface 214 provides a clock source 602 used to both strobe outbound serialized data from a serializer 604 (which converts data into a serial format) as well as to a clock phase delta computation block 626 based on a received clock signal from a local clock data recovery (CDR) circuit 624 (the clock phase delta computation block 626 is discussed further below). The switch interface 214 includes a driver 606 that drives an output signal from the serializer 604. Although one lane is shown, note that there can be more lanes, such as a four-lane port.

In FIG. 6, an oval 634 represents an electrical-optical converter that converts electrical output signals (containing streams of data) of the driver 606 to corresponding optical signals to be communicated in optical signal conduits 210 between the switch interface 214 and the NIC 212.

Signals transmitted by the driver 606 are received by a receiver 608 in the NIC 212 of an electronic device 102. An oval 636 represents an electrical-optical converters to convert received optical signals received into electrical signals to provide to the receiver 608.

In the example of FIG. 6, the output of the receiver 608 provides a stream of data that has been received from the driver 606 of the switch interface 214. The data stream output by the receiver 608 is provided to a de-serializer 610 and a CDR circuit 612, which is able to extract the clock signal timing associated with the received data stream (as received by the driver 608).

The recovered clock frequency is provided from the CDR circuit 612 to a clock phase adjustment block 614 and the de-serializer 610 in the NIC 212. The clock phase adjustment block 614 in turn produces a phase adjusted output clock that is used to drive a serializer 616 and a driver 618 in the NIC 212. The driver 618 transmits a data stream to the switch interface 214. An oval 630 represents electrical-optical converter of the NIC 212.

A data stream is received by receiver 620 in the switch interface 214 (oval 632 represents an electrical-optical converter of the switch interface 214). The output data stream from the receiver 620 is provided to a de-serializer 622 and the CDR circuit 624 in the switch interface 214. Additionally, note that there is a receiver 620 and CDR circuit 624 for each lane.

In some examples, to minimize (or reduce) clock signal lock and clock recovery times, a clock phase delta is calculated by the clock phase delta computation block 626 in the switch interlace 214. The clock phase delta can refer to the difference in phase between the clock signal of the local dock source 602 in the switch interface 214 and the recovered clock in the NIC 212. In specific examples, calculation of the clock phase delta can be performed during each NIC's PMD (physical medium dependent) training period in a Multi-point MAC Control Protocol (MPCP) layer (as described in IEEE 802.3ah).

The clock phase delta is sent to the NIC's clock phase adjustment block 614 via the NIC's MPCP layer. Each NIC's transmit clock phase is adjusted by its phase adjust block 614 until the received signal at the switch interface receiver 620 is synchronized with the local source clock 602. The clock phase delta is recalculated repeatedly by the clock phase delta computation block 626 and sent (if adjustment is to be performed at the NIC 212) to the NIC's phase adjustment block 614. The clock phase delta can be sent in either existing messaging or new messaging, such as a protocol data unit (PDU) of the MPCP layer.

Although FIG. 6 shows clock synchronization between one serial data lane of one NIC 212 and the switch interface 214, note that there are multiple lanes and multiple NICs that are coupled to the switch interface 214. Corresponding clock synchronizations can be performed between the multiple NICs 212 and the switch interface 214.

If multiple lanes of a multi-lane port in the NICs 212 of the electronic devices 102 are enabled (such as according to the FIG. 4B configuration), then a switch interface port (e.g. switch interface port 0 in FIG. 3) would be shared by multiple NICs. The shared switch interface port can transmit signal streams by multicasting the signal streams to all sharing NICs 212. However, in the opposite direction (from NICs to the shared switch interface port), just one NIC 212 is allowed to transmit signals streams at a time to the shared switch interface port.

In accordance with some implementations, an arbitration mechanism can be provided to control NICs sharing the switch interface port such that just one NIC is granted access to transmit at a time. The arbitration mechanism can be implemented in the switch interface 214 and in each of the NICs 212.

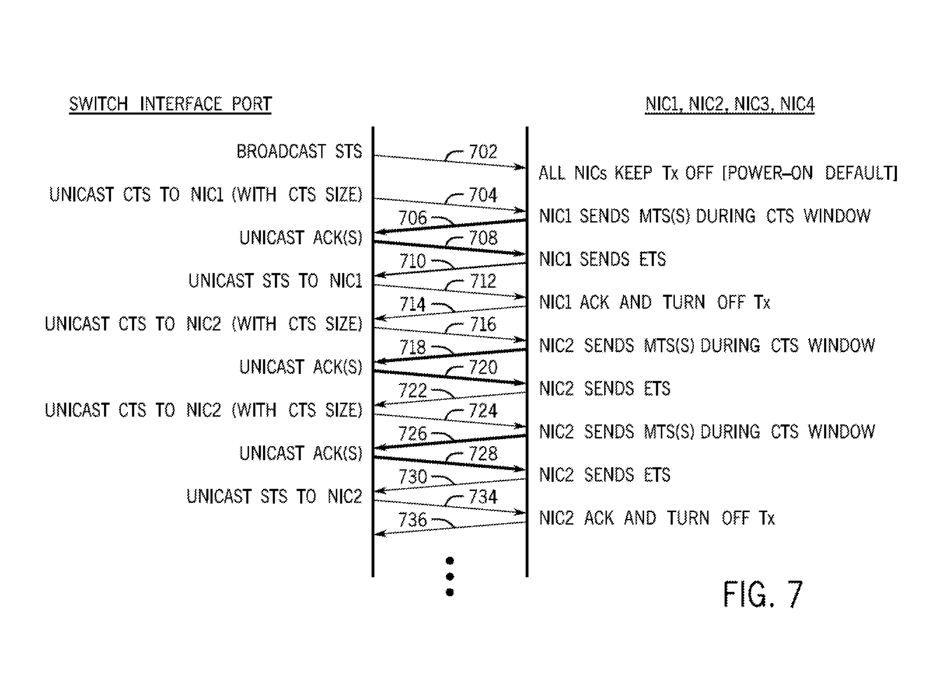

FIG. 7 depicts a message flow diagram according to some examples to implement an arbitration protocol, which can be a time-division multiplexing (TDM) arbitration protocol where different NICs are assigned to transmit during different windows. Although specific messages are depicted in FIG. 7, note that other types of messages or control signals can be used in other examples to perform arbitration to control NICs 212 to transmit one at a time to a shared switch interface port.

A switch interface port (e.g. switch interface port 0 in FIG. 3) broadcasts (at 702), over a shared bus to multiple NICs (e.g. NICs 212 in group 310 in FIG. 3), a STS (Stop to Send) frame. This causes the receiving NICs to keep their transmitters off (which is the default power-on state). In the ensuing discussion, the NICs of the group sharing a particular switch interface port are labeled NIC1, NIC2, NIC3, and NIC4.

The switch interface port next, sends (at 704) a CTS (Clear to Send) frame to a selected NIC (e.g. NIC1). As noted in FIG. 7, the CTS frame can include an information element indicating a CTS size (or CTS window size), which represents an amount of data that the selected NIC can transmit over the shared bus.

In response to the CTS message, the selected NIC (e.g. NIC1) transmits (at 706) data to the switch interface port. The transmitted data can be in one or multiple MTS (More to Send) frames, where each MTS frame can include a data payload to carry data. The transmission of the MTS frame(s) is during the CTS window (indicated by the CTS window size in the CTS frame). In response to each MTS frame transmitted by the selected NIC, the switch interface port unicasts (at 708) an acknowledgement (ACK) of the MTS frame.

The selected NIC (e.g. NIC1) next sends (at 710) sends an ETS (End to Send) frame to indicate end of transmission by the selected NIC. At least one information element in the ETS frame can be set as follows: (1) the information element can be set to a first value to indicate that the transmit buffer of the selected NIC becomes empty (due to data in the transmit buffer having been transmitted) before the CTS window size is used, or (2) the information element can be set to a second value to indicate that the CTS window size was used up before the transmit buffer of the selected NIC becomes empty.

In response to the ETS frame, the switch interface port unicasts (at 712) an STS frame to the selected NIC (e.g. NIC1).

NIC1 then sends (at 714) an ACK of the STS frame (712), and turns off its transmitter. The switch interface 214 can then select the next NIC (e.g. NIC2) to perform transmission on the shared bus. The selection of the next NIC can use a round-robin arbitration scheme or other type of arbitration scheme.

The switch interface port then unicasts (at 716) a CTS frame to NIC2, with the CTS frame containing a CTS size. Tasks 718, 720, and 722 are similar to tasks 706, 708, and 710, respectively, as discussed above.

Upon receiving the ETS frame at 722, the switch interface 214 may detect that NIC2 still has more data to transmit in its transmit buffer, but had to stop transmitting due to expiration of the CTS window. In this case, the switch interface 214 can re-grant the shared bus to NIC2 again, by unicasting (at 724) a CTS frame to NIC2. Tasks 726, 728, 730, 734, and 736 are similar to tasks 706, 708, 710, 712, and 714, respectively, as discussed above.

The process of FIG. 7 can continue with the granting of the shared bus to other NICs.

When multiple NICs are sharing a bus to a switch interface port, it may be possible that a NIC's receive buffer (to buffer data transmitted from the switch interface port to the NICs sharing the bus) can be overrun, which refers to the receive buffer filling up and unable to buffer any further data transmitted by the switch interface port. During a time window assigned to another NIC during which a particular NIC is unable to transmit over the shared bus, the particular NIC would not be able to provide an overrun indication to the switch interface port (to cause the switch interface port to pause transmission of data).

To address the foregoing issue, various mechanisms can be implemented. For example, the receive buffer of each NIC can be increased in size to allow the receive buffer to sink traffic at the traffic communication rate from the switch interface port during time windows assigned to other NICs.

Alternatively, a mechanism can be provided to allow transmission from the switch interface port to a NIC only during the NIC's assigned time window so that the NIC can respond with an overrun indication if the NIC's receive buffer reaches a predefined depth.

As yet another example, it is assumed that a NIC has multiple receive queues that are associated with respective priorities. In other words, a first of the receive queues is used to buffer data associated with a first priority, a second of the receive queues is used to buffer data associated with a second priority, and so forth. During initialization of the NIC, the NIC can send Q-Size[p] for each of its receive queues (where p can have different values to represent respective priorities). The parameter Q-Size[p] indicates the size of the corresponding receive queue (for receiving traffic of priority p). Also, the NIC sends Q-Depth[p] for each of its receive queues at the end of its assigned time window (during which the NIC is able to transmit over the shared bus). The parameter Q-Depth[p] represents the depth of the receive queue for priority p. The switch interface can maintain Q-Size[n,p] and Q-Depth[n,p] for each NIC (where n represents the corresponding NIC) and priority (p). During a time window not assigned to NIC n, data sent from the switch interface port is controlled to be capped at Q-Avail[n,p]=Q-Size[n,p]−Q-Depth[n,p].

In further examples, a NIC can also send a parameter Q-AvgDrainRate[p], which represents a weighted running average of how fast the NIC is able to absorb or sink traffic for each corresponding priority p. The parameter Q-AvgDrainRate[p] can be used by the switch interface to calculate a dynamic parameter Q-Avail[n,p](t), given the NIC's last known Q-Depth[n,p] and the amount of data transmitted from the corresponding switch interface's egress queue [n,p]. The dynamic parameter Q-Avail[n,p](t) can be used to calculate Q-Avail[n,p] for the muted NICs to control the amount of data to transmit from the switch interface port.

Note that certain NICs support a shared receive memory pool, which can be used to expand the size of a receive buffer for multiple traffic priorities. Information relating to the size of this shared receive memory pool can also be communicated to the switch interface for use in determining how much data can be sent by the switch interface port to the NIC.

Alternatively, some combination of the foregoing techniques can be used.

Machine-readable instructions of modules described above (including the control logic 322 or switch logic 302 of FIG. 3) can be loaded for execution on a processor. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; or other types of storage devices. Note that the instructions discussed above can be provided on one computer-readable or machine-readable storage medium, or alternatively, can he provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. An apparatus comprising:
an optical connection infrastructure having optical signal conduits between first devices and at least one second device; and
a controller to cause dynamic reconfiguration of the optical connection infrastructure from a first connection topology to a second, different connection topology based on programmatic reconfiguration of the first devices.

2. The apparatus of claim 1, wherein the first devices include network interface components each having a port with multiple lanes connected to corresponding ones of the optical signal conduits, wherein programmatic reconfiguration of the first devices enables or disables corresponding ones of the lanes.

3. The apparatus of claim 2, wherein the programmatic reconfiguration of the port of a particular one of the network interface components causes a subset of the lanes of the port of the particular network interface component to be enabled, and causes another subset of the lanes of the port of the particular network interface component to be disabled.

4. The apparatus of claim 3, wherein the programmatic reconfiguration of the port of the particular one of the network interface components enables provision of a star topology or hybrid star-bus topology.

5. The apparatus of claim 2, wherein the programmatic reconfiguration of the port of a particular one of the network interface components causes all of the lanes of the port of the particular network interface component to be enabled.

6. The apparatus of claim 5, wherein the programmatic reconfiguration of the port of the particular one of the network interface components enables provision of a shared bus topology or hybrid star-bus topology.

7. The apparatus of claim 1, wherein the dynamic reconfiguration of the optical connection infrastructure is to be performed without physically changing any physical component of the optical connection infrastructure.

8. The apparatus of claim 1, wherein the first connection topology and second connection topology are different topologies selected from the group consisting of a star topology, a bus topology, and a hybrid star-bus topology.

9. A method comprising:
providing an optical connection infrastructure having optical signal conduits between electronic devices and at least a switch; and
dynamically reconfiguring the optical connection infrastructure from a first connection topology to a second, different connection topology based on programmatic reconfiguration of the electronic devices.

10. The method of claim 9, wherein the second connection topology includes a shared bus topology that allows a group of the electronic devices to share a port of the switch, the method further comprising:
performing arbitration to control when selected ones of the electronic devices in the group are able to transmit data to the port of the switch.

11. The method of claim 10, wherein the arbitration includes time-division multiplexing arbitration.

12. The method of claim 9, further comprising:
performing clock synchronization between each of the electronic devices and the switch.

13. The method of claim 12, wherein the clock synchronization includes each of the electronic devices recovering a clock signal timing based on a data stream from the switch received by the corresponding electronic device, and the switch recovering a clock signal timing based on a data stream received from each electronic device received by the switch.

14. The method of claim 9, further comprising:
performing flow control to prevent overrun of a receive buffer in an electronic device.

15. A system comprising:
first devices;
a second device;
an optical connection infrastructure having optical conduits to interconnect the first devices to the second device,
wherein the first devices are programmable between different settings to cause dynamic reconfiguration of the optical connection infrastructure between a first network topology and a second network topology, without changing any physical component of the optical connection infrastructure.
